(19) United States
(12) Patent Application Publication
(10) Pub. No.: US 2005/0004969 A1
(43) Pub. Date: Jan. 6, 2005

(54) System for information exchange for integration of multiple data sources

(75) Inventors: Gregory J. McRae, Winchester, MA (US); Cheng Wang, San Diego, CA (US)

Correspondence Address: FOLEY & LARDNER, P.O. BOX 80278, SAN DIEGO, CA, 92138-0278, US

(73) Assignee: Reaction Design, LLC

(21) Appl. No.: 10/613,706

(22) Filed: Jul. 3, 2003

(51) Int. Cl. G06F 15/16

(52) U.S. Cl. 709/200

(57) ABSTRACT

The disclosed systems and methods are directed to exchange of uncertainty information between interacting modules. Variances in the outputs of one module may be required as uncertainties in the inputs of another module. The disclosed systems and methods allow for simple and efficient communication of the uncertainty information between any modules. In one aspect, a system of integrated modules includes one or more application modules and at least one interface module. The application modules are adapted to receive inputs and/or generate outputs, including uncertainty distribution information. The interface modules are adapted to communicate with one or more application modules and to translate uncertainty information between a predetermined uniform format and an application-specific format. In one embodiment, an extensible markup language (XML) format is used for the predetermined uniform format.

### FIELD OF THE INVENTION

The invention relates to data exchange systems. More particularly, the invention provides a system for exchanging data between application modules, including uncertainty distribution information.

### BACKGROUND

Integration of multiple processes or systems is a necessity in many industries. Transfer of information between distinct processes or systems is often accomplished by manual means. For example, output information from a first system may be typed in as input for a second system. Even when the output information from the first system is available in electronic form, it often requires re-formatting in order to be used as input for the second system. This results in tremendous inefficiencies, particularly when the systems or processes must be repeated, as may be the case in, for example, feedback systems.

An integrated system may include systems or processes using a variety of commercially available packages. Such packages often are not adaptable to interact with each other. For example, in a system for simulating a chemical plant, the output from a reactor model using, for example, Chemkin may not be acceptable as input by a CFD module using, for example, STAR CD.

Further challenges are posed by the need to incorporate uncertainty information, as may be required for certain input or output parameters. For example, an input parameter may have a nominal value with an associated probability density distribution which results in a probability distribution of one or more output parameters. This output probability distribution may be required as an input for yet another process or system, thus requiring efficient transfer not only of nominal parameter values, but also of their probability density distribution.

The Chemistry WebBook database maintained by National Institute of Standards and Technology (NIST) provides maximum and minimum values and/or a range of values as uncertainties for various parameters in a chemical reaction. However, such a system only provides either a uniform distribution or a predetermined distribution of the probability function.

### SUMMARY OF THE INVENTION

The disclosed systems and methods are directed to exchange of uncertainty information between interacting modules. Variances in the outputs of one module may be required as uncertainties in the inputs of another module. The disclosed systems and methods allow for simple and efficient communication of the uncertainty information between any modules.

In one aspect of the invention, a system of integrated modules includes one or more application modules adapted to receive inputs and/or generate outputs. The inputs and outputs include uncertainty distribution information.

An application module may be any component of a system of processes, mechanisms, or algorithms. An application module may include a process, a sub-process, a mechanism, an algorithm step, a calculation, or a software package simulation. Further, an application module may be a part of or one or more processes, sub-processes, mechanisms, algorithm steps, calculations, simulations or other components.

Inputs are parameters that are used by one or more modules. Inputs may include, for example, internal or external parameters that may be preset, provided by a user, or provided by another module.

Outputs are parameters that are generated by one or more modules. Outputs may include parameters that are generated by a module in response to one or more inputs.

Uncertainties may be uncontrollable variations in the inputs that may cause variations in the outputs. Uncertainties may be distributed continuously or discretely over a range of values. Uncertainty distribution may be the probability of occurrence of any value of a variable. For example, a Gaussian distribution may indicate the likelihood of occurrence of a variable value between −∞ and +∞.

The system further includes at least one interface module adapted to communicate with one or more application modules. The interface module is adapted to translate uncertainty information from any one of the application modules to a predetermined uniform format and/or to translate uncertainty information from the predetermined uniform format to an application-specific format.

An interface module may be a software package, routine or set of routines. A predetermined format may be a way of presenting data which is readily translated by other application modules. An application-specific format may be a data presentation format that is unique to a particular application module.

In another aspect of the invention, a system of integrated modules includes application means for receiving inputs and/or generating outputs. The inputs and the outputs include uncertainty distribution information.

The application means may be any component of a system of processes, mechanisms, or algorithms and may include a process, a sub-process, a mechanism, an algorithm step, a calculation, or a software package simulation. Further, the application means may be a part of or one or more processes, sub-processes, mechanisms, algorithm steps, calculations, simulations or other components.

The system further includes interface means for communicating with the application means. The interface means is adapted to translate uncertainty information to a predetermined uniform format and/or to translate uncertainty information from the predetermined uniform format to an application-specific format.

In a preferred embodiment, the uncertainty distribution information is indicative of a type of distribution and includes data indicative of uncertainty densities.

A distribution type may be a description of likelihood of possible values of a variable. Possible distribution types may be Gaussian, lognormal and exponential.

In a further preferred embodiment, the uniform format is an extensible markup language (XML) format. The XML format is well known to those skilled in the art. The XML format may include an uncertainty description element and one or more data elements, the data elements being determined according to the description element.

An element is a data component in an XML format. The description element may be associated with a distribution type, and the data elements may be associated with characteristic parameters of the distribution type. Characteristic parameters may be parameters whose values define the likelihood of occurrence of a particular value of a variable based on the type of distribution. For example, a mean value and a standard deviation value may define the likelihood of occurrence of any value of a variable having a Gaussian distribution.

A value of the description element may be one of the set consisting of normal probability density function, exponential probability density function, polynomial chaos expansion, list of points, and histogram.

In a preferred embodiment, the application module may be associated with an input interface module and an output interface module. The input interface module may be adapted to communicate with an output interface module of another application module. The output interface module may be adapted to communicate with an input interface module of another application module

In a preferred embodiment, the system further includes a platform module for controlling communication with the application module through the interface module. The platform module is adapted to control data flow to and from the application modules.

The platform module may include a graphic user interface module for displaying information to a user and receiving inputs from a user. A graphic user interface module may be a software package, a routine or a set of routines adapted to allow communication between a user and a system. The graphic user interface module may display data in graphic form to the user.

The platform module may include an optimization module for optimizing a system uncertainty in response to the application module. The optimization module may be a software package or a routine for either maximizing or minimizing an objective function. The objective function may be any parameter or combination of parameters whose value is desired to be either minimized or maximized. The optimization module may be adapted to iterate to a convergence of a mean value.

In another aspect of the invention, a method for exchanging data includes receiving an output from an application module. The output includes a set of values for an output parameter. The set of values is indicative of a variance in the output parameter.

The set of values may be possible values of an output parameter. The variance may be a distribution of the output parameter caused by an uncertainty in one or more inputs of the application module.

The method further includes selecting a distribution type from a predetermined list of types, the selecting being based on a distribution of the set of values.

A distribution type may be a description of likelihood of possible values of a variable. Possible distribution types may be Gaussian, lognormal and exponential.

The method also includes determining values of one or more characteristic parameters, the characteristic parameters being associated with said selected distribution type.

In a preferred embodiment, the method further includes generating an output set, the output set including the selected distribution type and the values of said characteristic parameters. In a further preferred embodiment, the output set is in an XML format.

### BRIEF DESCRIPTION OF THE DRAWINGS

In the following, the invention will be explained in further detail with reference to the drawings, in which:

FIG. 1 illustrates a system having an interface module according to one embodiment of the invention;

FIGS. 2A and 2B illustrate systems according to embodiments of the invention having a plurality of application modules exchanging information through interface modules;

FIGS. 3A and 3B illustrate systems according to embodiments of the invention having a productivity platform module for facilitating exchange of data between a plurality of application modules;

FIG. 4 illustrates one embodiment of a productivity platform module according to an embodiment of the invention;

FIG. 5 illustrates the convergence of a probability density function through an iterative process performed by a system according to an embodiment of the invention;

FIGS. 6A and 6B illustrate one embodiment of a data architecture for exchanging uncertainty distribution information in a system according to an embodiment of the invention; and

FIGS. 6C and 6D illustrate another embodiment of a data architecture for exchanging uncertainty distribution information in a system according to an embodiment of the invention.

### DESCRIPTION OF CERTAIN EMBODIMENTS OF THE INVENTION

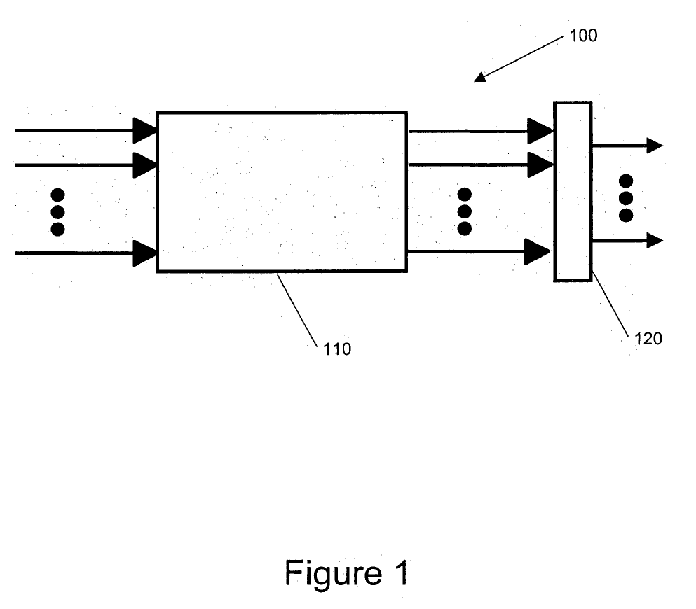

FIG. 1 illustrates a system of integrated modules adapted to exchange information, including uncertainty distribution information, between application modules. The system 100 comprises an application module 110 in communication with an interface module 120. The application module 110 may be, for example, a software package, a process, an algorithm or a simulation. The application module 110 may include a portion of a process, algorithm, simulation or other. Further, the application module 110 may include two or more such processes, algorithms, simulations or other. For example, in a chemical reactor system, the application module 1110 may be a computational fluid dynamics (CFD) simulation package.

The application module 110 is adapted to receive one or more inputs from, for example, a user, an external source, or a predetermined, internally provided input. The inputs are used by the application module 110 to generate one or more outputs. One or more of the inputs may have an associated uncertainty distribution. For example, an input such as an environment temperature may have an uncontrolled uncertainty which may be defined as a Gaussian distribution or a lognormal distribution. Of course, other distributions are possible.

The application module 110 may be adapted to propagate the uncertainties in the inputs to the outputs of the application module 110. This may be performed in one of many ways, such as a Monte Carlo analysis. In other embodiments of the invention, the propagation of uncertainties may be more efficiently accomplished by first generating a deterministically equivalent model of the application module, as described in U.S. Patent Application, titled “METHOD AND SYSTEM FOR INTEGRATED UNCERTAINTY ANALYSIS,” Attorney Docket No. 037010-0105, filed concurrently herewith and hereby incorporated by reference in its entirety.

The outputs of the application module 110 may, thus, include variances reflecting propagated input uncertainties. In a system of interacting application modules, the uncertainty information in the outputs of the application module 110 may be required as an input for another application module.

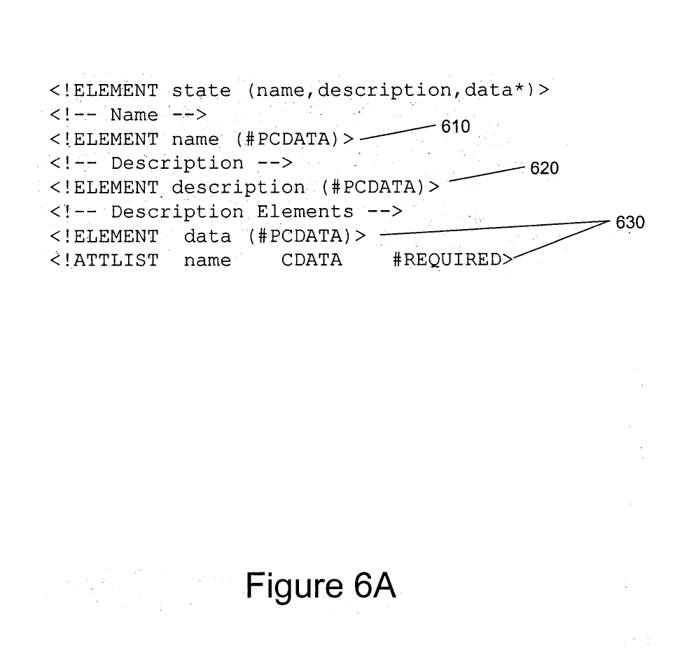

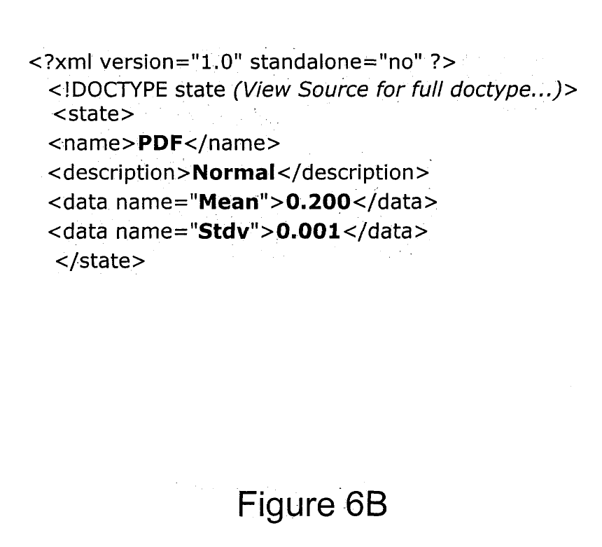

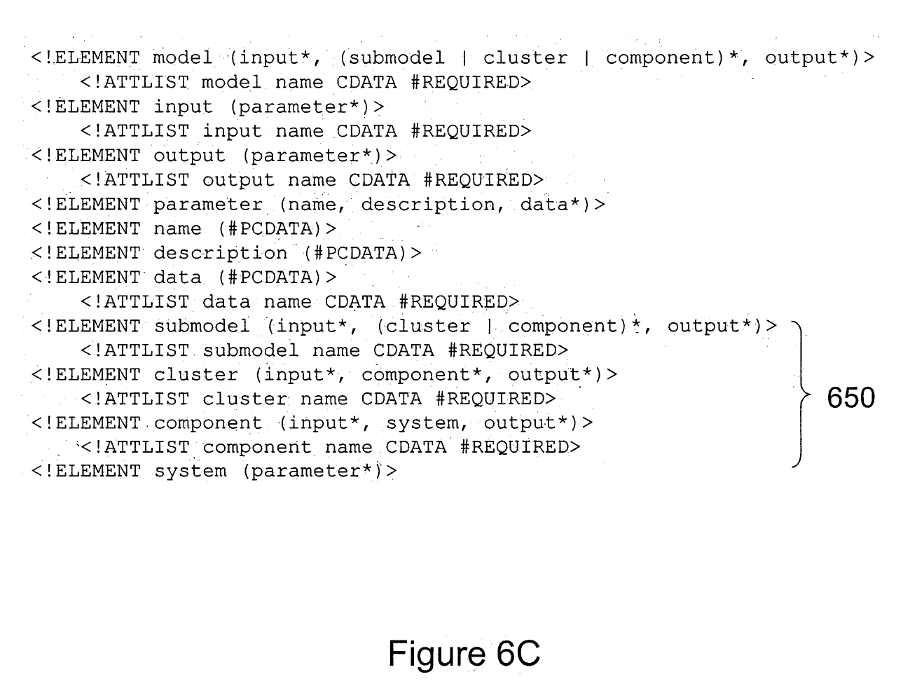

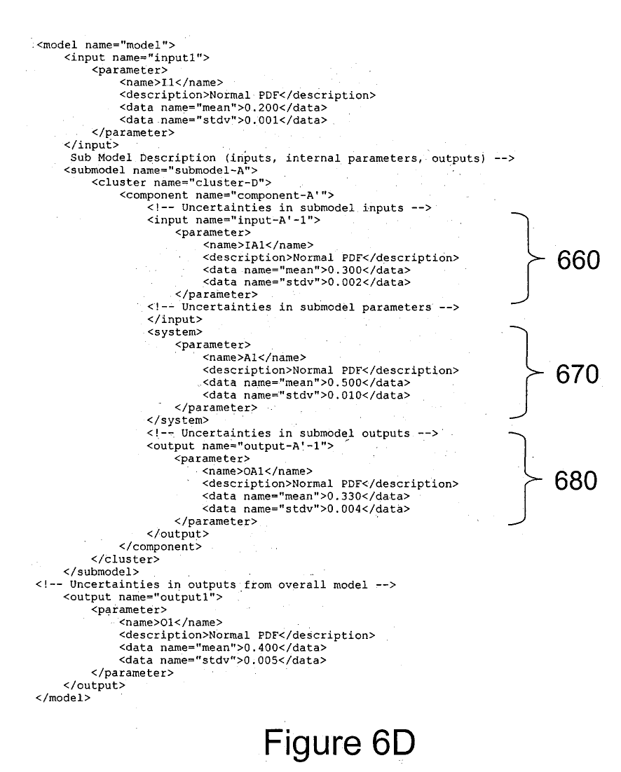

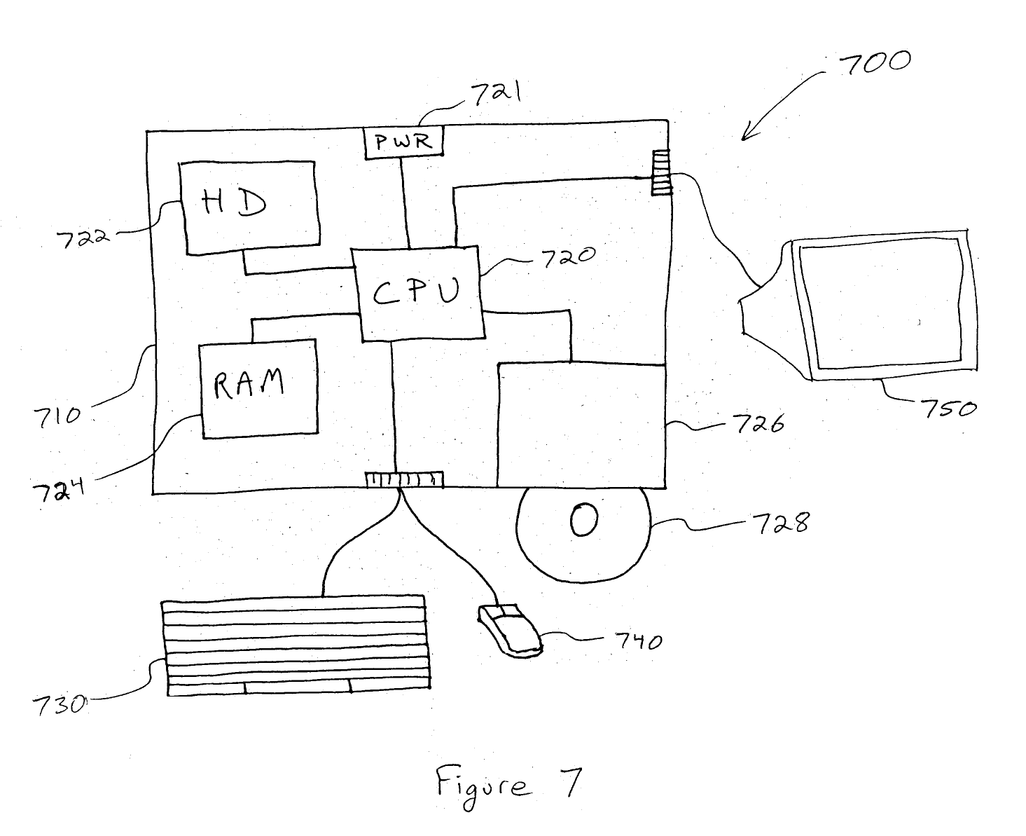

The interface module 120 is adapted to receive the outputs of the application module 110 and to generate an output set in a predetermined uniform format adapted to be accessible by other application modules. As described below with reference to FIGS. 6A and 6B, the predetermined format of the interface module 120 includes uncertainty information relating to the various output parameters of application module 110. The uncertainty information is provided in a format that is readily accessible by any other module such as an application module or another interface module.

In one embodiment, the interface module 120 may receive raw data relating to variances in the outputs due to the input uncertainties. The interface module 120 may then determine the type of probability density function that best describes the distribution of each output parameter. The determination of the type of function may be accomplished by selecting from a predetermined set of distribution types. For example, a Monte Carlo analysis may yield a distributed set of output parameter values. This set of values may be used by the interface module 120 to determine that the distribution is best described by a normal Gaussian distribution function with a mean and a standard deviation. The Gaussian distribution function may be one among a list of types from which the interface module 120 may select. In addition to Gaussian, the list may include lognormal, polynomial chaos expansion (PCE), set of points, etc. For each distribution type in the list, one or more characteristic parameters, such as mean and standard deviation, may be determined by the interface module 120 to fully define the probability density distribution of the output parameter.

The interface module 120 may then generate an output set, as described below with reference to FIGS. 6A and 6B, which identifies the probability density distribution of each output parameter. This output set may then be used as an input by either another interface module or an application module. Thus, the interface module 120 translates output data from an application-specific format to a predetermined format.

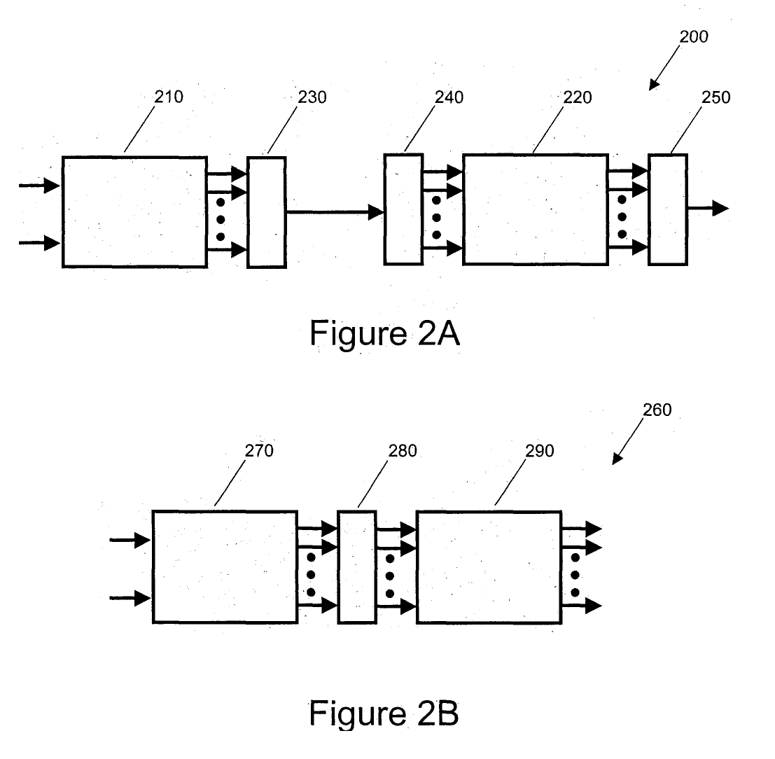

FIGS. 2A and 2B illustrate systems according to further embodiments of the invention. Referring first to FIG. 2A, an application module 210 is adapted to receive inputs and to generate a set of outputs to a first interface module 230. As described above with reference to FIG. 1, the interface module 230 generates an output set which includes the output information of the application module 210 as well as uncertainty information relating to output parameters of application module 210; The first interface module 230 communicates the output set to a second interface module 240. The second interface module 240 is adapted to receive the outputs of interface module 230 and translate that output set to a set of inputs for a second application module 220. The input set received from the second interface module 240 includes uncertainty information relating to each of the inputs to the second application module 220. Thus, uncertainties in the inputs to the first application module 210 are propagated through the application module 210 to the inputs to the second application module 220. The second application module 220 may now propagate those uncertainties through the application module 220 and to a third interface module 250 for further propagation to, for example, another application module.

Similarly, as illustrated in FIG. 2B, uncertainties and inputs to a first application module 270 may be propagated to inputs to a second application module 290 through a single interface module 280. In this system 260, the interface module 280 directly translates the uncertainties in the outputs of the first application module 270 to uncertainties in the inputs of the second application module 290.

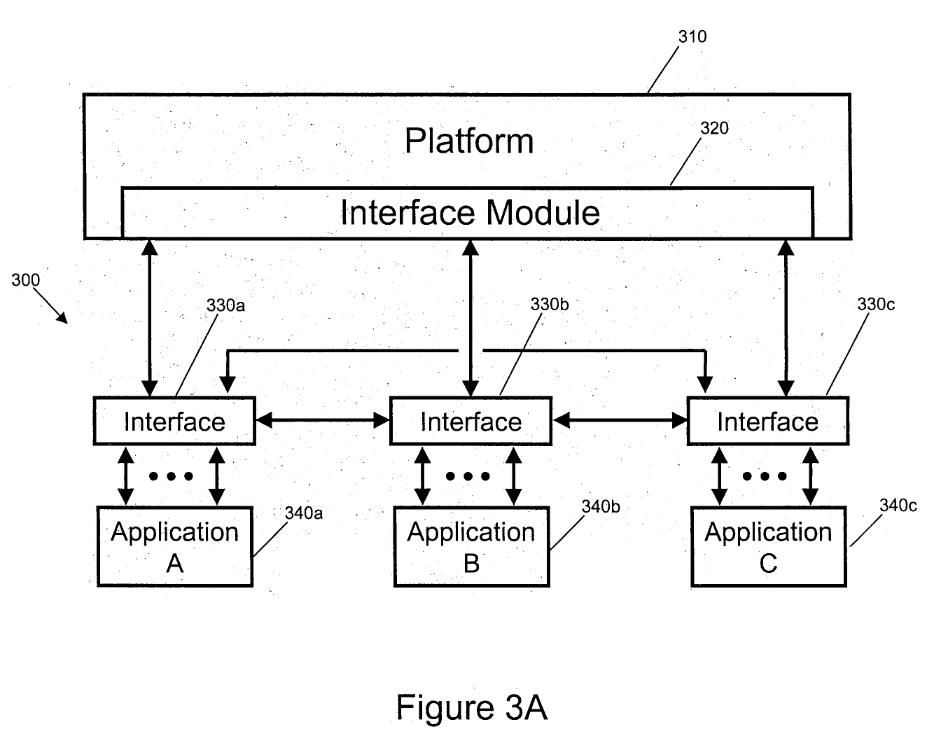

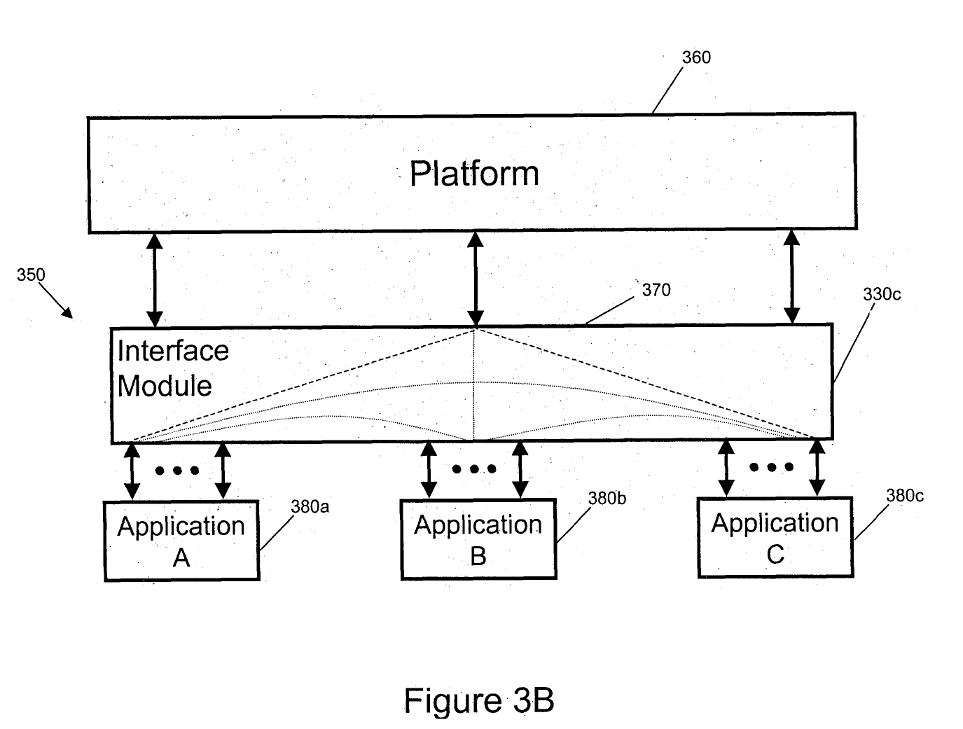

FIGS. 3A and 3B illustrate systems according to further embodiments of the invention. Referring first to FIG. 3A, a productivity platform module 310 is provided to interact with a plurality of application modules and interface modules. The productivity platform module 310 is provided with an internal interface module. In other embodiments of the invention, the interface module may be an external module communicating with the productivity platform module 310. A plurality of application modules 340A-C are each provided with an interface module 330A-C for communication with other application modules as well as with the productivity platform module 310. Each application module 340A-C generates data including uncertainty information relating to various output parameters. The outputs of the application modules 340A-C may be provided through the interface modules 330A-C to an interface module of another application module or the productivity platform 310. Similarly, each application module 340A-C may receive inputs, including uncertainty information relating to each input, from other application modules or from the productivity platform 310 through an interface module 330.

In another embodiment, as illustrated in FIG. 3B, a single interface module may be provided for communication between the application modules 380A-C and a productivity platform 360. In this system 350, information being received by the interface module 370 from an application module 380A-C or the productivity platform module 360 may indicate the destination of the data as well. In this regard, the interface module is able to receive inputs and direct them to the proper destination.

Referring again to FIG. 3A, the productivity platform 310 may be adapted to interface with a user, thereby allowing a user to control operation of the various application modules, including adding or deleting various application modules.

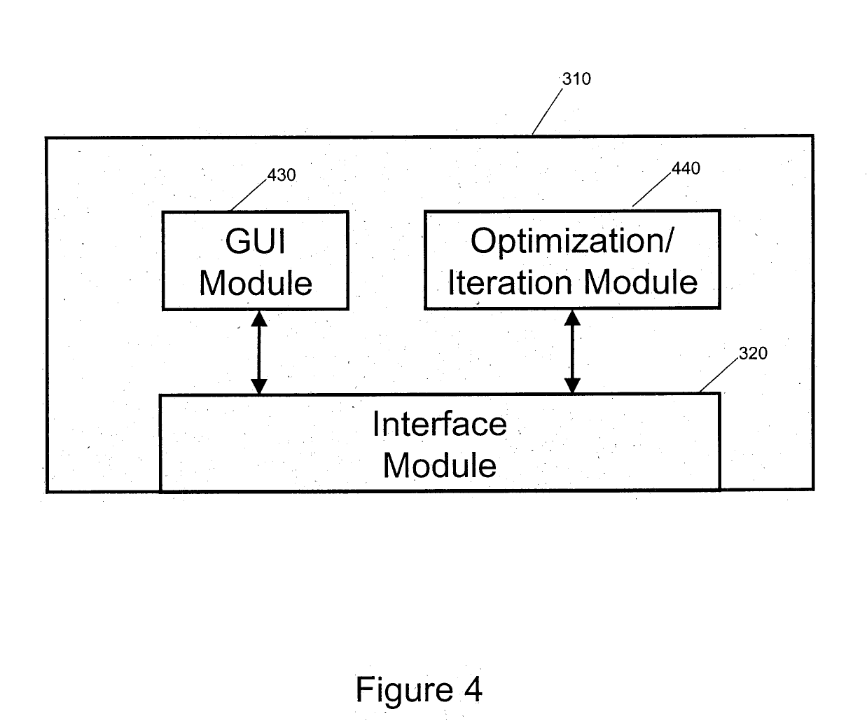

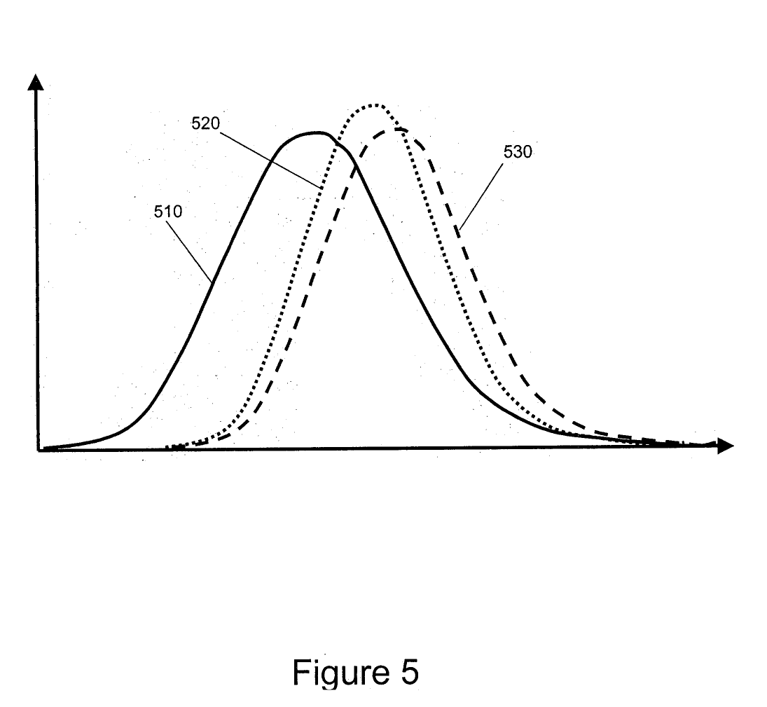

FIG. 4 illustrates one embodiment of a productivity platform module as illustrated in FIG. 3A. In the embodiment illustrated in FIG. 4, the productivity platform module 310 is provided with the interface module 320, as illustrated in FIG. 3A. The interface module allows the productivity platform module 310 to exchange data with various application modules. Further, a graphic user interface (GUI) module 430 may be provided to allow a user to interact with the platform module and, through the interface module, with the various application modules. In this regard, the GUI module 430 may be adapted to receive inputs from the user and to provide a display output to the user. Further, the GUI module 430 may allow the user to activate an optimization/iteration module 440. The optimization/iteration module 440 may be adapted to optimize a particular objective function relating to one or more of the application modules. In one embodiment, the optimization/iteration module 440 is adapted to converge an uncertainty distribution of a particular parameter to a optimized solution. As illustrated in FIG. 5, for example, a first iteration of the various applications may provide an uncertainty distribution of a particular parameter as illustrated by the solid line 510 in FIG. 5. By iterating on a particular variable or variables, successive iterations may produce uncertainty distributions as illustrated by lines 520 and 530 on FIG. 5. The iterations may continue until the difference between the uncertainty distributions resulting from successive iterations is less than a predetermined threshold.

The optimization/iteration module 440 may be based on any one of several well-known optimization or iteration algorithms. For example, a sequential quadratic programming algorithm may be used.

FIGS. 6A and 6B illustrate one example of a common data architecture which may be used by the interface modules to propagate uncertainty information between application modules. FIGS. 6A and 6B illustrate a common data architecture using an extensible markup language (XML). The data architecture illustrated in FIG. 6A is adapted to accommodate any one of a group of uncertainty distributions. An element called 4“name” 610 is provided to identify the type of distribution for a particular variable. In the example illustrated in FIG. 6B, the “name” of the distribution is PDF, or probability density function. Another element called “description” 620 is provided to further describe the distribution. For example, in the example of FIG. 6B, several types of PDF distributions may be possible, including a “normal” distribution. Other PDF distributions may include exponential PDF distribution. Depending on the “name” and the “description” of the uncertainty distribution of the particular variable, one or more description elements may be provided to describe the actual distribution. In this regard, FIG. 6A illustrates the data architecture as including an attribute list 630 which is a function of the “name” and “description” parameters. For example, the example illustrated in FIG. 6B has a normal PDF distribution, requiring that the mean and the standard deviation be specified in order to completely describe the distribution.

Similarly, other uncertainty distribution types may be specified for each variable. For example, the uncertainty distribution of a variable having an exponential PDF distribution may be described by providing a mean value. Other distribution types that may be described using this common data architecture may include a polynomial chaos expansion, a list of points, or a histogram. Thus, the uncertainty distribution of each variable, input or output may be associated with the variable itself in, for example, a database.

FIGS. 6C and 6D illustrate another embodiment of a data architecture for use with interfaced modules. In this embodiment, uncertainty in inputs, internal parameters and outputs can be represented at various levels in a hierarchy of modeling details. For example, the data architecture illustrated in FIG. 6C allows the implementation of one or more submodels 650 within each data model. In the XML data file, data may be provided for submodel inputs 660, submodel parameters 670 and submodel outputs 680. Further levels of submodels in the hierarchy may be similarly represented.

An embodiment of the invention may be implemented on a processor such as the computer system illustrated in FIG. 7. The computer system 700 comprises a computer such as a desktop unit 710 or a laptop. Processing is performed by a central processor unit (CPU) 720. The CPU 720 may receive electrical power from a power supply 721 connected to an external power source.

A hard drive 722 may be provided to store data and instructions in a non-volatile memory, for example. Further, a random access memory 724 is provided to temporarily store instructions for the CPU. The random access memory 724 may be provided with stored instructions by, for example, an executable residing on the hard drive 722 or on an external storage medium such as a floppy disk or a CD-ROM 728. Information on the CD-ROM 728 may be accessed by the CPU 720 via a CD-ROM drive 726. Other drives may be provided to access information from other types of external storage media.

The CPU 720 may receive instructions, commands or data from an external user through input devices such as a keyboard 730 and a mouse 740. The CPU 720 may display status, results or other information to the user on a monitor 750.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

1. A system of integrated modules, comprising:
one or more application modules adapted to receive inputs and/or generate outputs, said inputs and said outputs including uncertainty distribution information; and
at least one interface module adapted to communicate with one or more application modules, said interface module adapted to translate uncertainty information from any one of said application modules to a predetermined uniform format and/or to translate uncertainty information from said predetermined uniform format to an application-specific format.

2. The system according to claim 1, wherein said uncertainty distribution information is indicative of a type of distribution and includes data indicative of uncertainty densities.

3. The system according to claim 1, wherein said uniform format is an extensible markup language (XML) format.

4. The system according to claim 3, wherein said XML format includes an uncertainty description element and one or more data elements, said data elements being determined according to said description element.

5. The system according to claim 4, wherein a value of said description element may be one of the set consisting of normal probability density function, exponential probability density function, polynomial chaos expansion, list of points, and histogram.

6. The system according to claim 1, wherein each of said application modules is associated with an input interface module and an output interface module;
wherein said input interface module is adapted to communicate with an output interface module of another application module; and
wherein said output interface module is adapted to communicate with an input interface module of another application module.

7. The system according to claim 1, further comprising:
a platform module adapted to control communication with said application modules through at least one interface module, said platform module being adapted to control data flow between said application modules.

8. The system according to claim 7, wherein said platform module includes a graphic user interface module for displaying information to a user and receiving inputs from a user.

9. The system according to claim 7, wherein said platform module includes an optimization module adapted to optimize a system uncertainty in response to said application modules.

10. The system according to claim 9, wherein said optimization module is adapted to iterate to a convergence of a mean value.

11. A system of integrated modules, comprising:
application means for receiving inputs and/or generating outputs, said inputs and said outputs including uncertainty distribution information; and
interface means for communicating with said application means, said interface means adapted to translate uncertainty information to a predetermined uniform format and/or to translate uncertainty information from said predetermined uniform format to an application-specific format.

12. The system according to claim 11, wherein said uncertainty distribution information is indicative of a type of distribution and includes data indicative of uncertainty densities.

13. The system according to claim 11, wherein said uniform format is an extensible markup language (XML) format.

14. The system according to claim 13, wherein said XML format includes an uncertainty description element and one or more data elements, said data elements being determined according to said description element.

15. The system according to claim 14, wherein a value of said description element may be one of the set consisting of normal probability density function, exponential probability density function, polynomial chaos expansion, list of points, and histogram.

16. The system according to claim 11, wherein said application means is associated with an input interface means and an output interface means;
wherein said input interface means is adapted to communicate with an output interface means of another application means; and
wherein said output interface means is adapted to communicate with an input interface means of another application means.

17. The system according to claim 11, further comprising:
platform means for controlling communication with said application means through said interface means, said platform means being adapted to control data flow to and from said application means.

18. The system according to claim 17, wherein said platform means includes a graphic user interface means for displaying information to a user and receiving inputs from a user.

19. The system according to claim 17, wherein said platform means includes an optimization means for optimizing a system uncertainty in response to said application means.

20. The system according to claim 19, wherein said optimization means is adapted to iterate to a convergence of a mean value.

21. A method for exchanging data, comprising:
receiving an output from an application module, said output including a set of values for an output parameter, said set of values being indicative of a variance in the output parameter;
selecting a distribution type from a predetermined list of types, said selecting being based on a distribution of said set of values; and
determining values of one or more characteristic parameters, said characteristic parameters being associated with said selected distribution type.

22. The method according to claim 21, further comprising:
generating an output set, said output set including said selected distribution type and said values of said characteristic parameters.

23. The method according to claim 22, wherein said output set is in an XML format.
